(19) United States
(12) Patent Application Publication
(10) Pub. No.: US 2006/0169107 A1
(43) Pub. Date: Aug. 3, 2006

(54) Fastener tightening device

(75) Inventors: Takao Taniguchi, Anjo-shi (JP); Shigeharu Ikeda, Anjo-shi (JP); Nobuyoshi Watanabe, Anjo-shi (JP)

Correspondence Address: BACON & THOMAS, PLLC, 625 SLATERS LANE, FOURTH FLOOR, ALEXANDRIA, VA, 22314, US

(73) Assignee: AISIN AW CO., LTD., Anjo-shi (JP)

(21) Appl. No.: 11/339,792

(22) Filed: Jan. 26, 2006

(30) Foreign Application Priority Data
Jan. 28, 2005 (JP) 2005-022293

(51) Int. Cl. B25B 17/00; B25B 23/14; B25B 23/02; B25B 13/00

(52) U.S. Cl. 81/57.22; 81/57.36; 81/467

(57) ABSTRACT

A bolt tightening device includes bolt tightening mechanisms, a torque input unit, a toothed belt and torque transmission units. The torque transmission units are provided with toothed pulleys and are integrated with the bolt tightening mechanisms. A toothed pulley is fixed to the torque input unit, and drivably connected to all the toothed pulleys of the plural torque input units by the single toothed belt. Torque input to the torque input unit is transmitted to the bolt tightening mechanisms by the toothed belt, and used to simultaneously tighten, for example, seven bolts. Because, torque can be simultaneously transmitted to plural bolt tightening mechanisms using a single belt, the number of components is reduced and the size, weight and cost are reduced and ease of use is improved.

### INCORPORATION BY REFERENCE

The disclosure of Japanese Patent Application No. 2005-022293 filed on Jan. 28, 2005, including the specification, drawings and abstract, is incorporated herein by reference in its entirety.

### BACKGROUND OF THE INVENTION

1. Field of the Invention

The present invention relates to a fastener tightening device that can simultaneously tighten a plurality of fasteners.

2. Description of the Related Art

An oil pump assembly of an automatic transmission is fixed to the housing of the automatic transmission by a plurality of bolts. Devices for simultaneously tightening such a plurality of bolts are known in the art, such as the bolt tightening device described in Japanese Patent Application Publication No. JP-A-9-216172, and a dual side bolt tightening device displayed at the 2004 TPM Exhibition of Machinery Improvement Concepts.

Such bolt tightening devices include a torque transmission unit and a plurality of rotary members. The torque transmission unit is provided with a socket that receives the drive shaft of an electric tool. The rotary members have bolt-holding sockets that hold the heads of the bolts. The single gear of the torque transmission unit is in mesh with all of the gears respectively associated with each of the rotary members. The torque of the electric tool connected to the torque transmission unit is transmitted to the rotary members via the gears to simultaneously rotate all of the rotary members, and thus simultaneously tighten all the bolts held by the bolt-holding sockets of the rotary members.

A dual bolt tightening tool is shown in FIG. 12 as including a drive shaft 40, rotary shafts 41, 42, and toothed belts 43, 44. Toothed pulleys 45 and 46 are axially aligned on and fixed to the drive shaft 40 and are thereby rotatably driven by the drive shaft 40. Sockets 47, 48, which hold the heads of the bolts, are respectively attached to distal ends of the rotary shafts 41, 42. Further, toothed pulleys 49, 50 are respectively attached to the base ends of the rotary shafts 41, 42. The toothed pulleys 45, 46 of the drive shaft 40 drive the toothed pulleys 49, 50 on the rotary shafts 41, 42 through the toothed belts 43, 44, respectively running therebetween. When the drive shaft 40 rotated, its torque is transmitted to the rotary shafts 41, 42 via the toothed belts 43, 44, whereby the rotary shafts 41, 42 are rotatably driven to simultaneously tighten the bolts held by the sockets 47, 48.

Because the above described bolt tightening device uses gears to transmit torque, if there is a large spacing between the plurality of bolts, the diameter of the gears on the torque transmitting shaft and the driven rotary shafts must be increased accordingly. However, if the diameter of the gears is increased, the weight of the bolt tightening device is also increased, which makes it harder to use the device.

The above-described dual bolt tightening device includes the toothed belts 43, 44 for respectively driving the rotary shafts 41, 42, the toothed pulleys 45, 46 and the drive shaft 40, which amount to a large number of components and thus high cost. Further, if it is necessary to tighten a larger number of bolts, the axial length of the drive shaft must be increased in order to allow an increase in the number of toothed pulleys mounted thereon.

### SUMMARY OF THE INVENTION

Accordingly, it is an object of the present invention to provide a small, lightweight and low cost fastener tightening device that is easy to use and that can tighten a plurality of fasteners at the same time, regardless of where the fasteners are positioned.

The device (tool) of the present invention is able to simultaneously tighten a plurality of fasteners and includes a plurality of rotary shafts including respective fastener holders; and a torque transmission unit that uses a single belt. Because the fastener tightening device of the present invention is able to transmit torque using a single belt, the number of components, the size and the weight of the device can be reduced. Further, since the device is lightweight it is easier to use. Torque from an external source may be input to one or more of the plurality of rotary shafts.

The device of the present invention may include a torque limiting unit that controls the torque of at least one of the plurality of rotary shafts, which allows the fasteners to be tightened to a predetermined torque. The torque limiting unit may control the pulleys on the rotary shafts to control the torque of the rotary shafts, making it possible to reliably tighten the fasteners to the predetermined torque.

Moreover, the torque transmission unit may include a tension adjustment unit that adjusts the tension of the belt to reliably transmit the torque of the torque generating unit to the rotary shafts.

Further, the fastener tightening device of the present invention may include a positioning unit for positioning the plurality of rotary shafts in alignment with the positions where the fasteners are to be inserted into the work and tightened.

### BRIEF DESCRIPTION OF THE DRAWINGS

FIG. 1 is a cross-sectional view of an automatic transmission;

FIG. 2 is a cross-sectional view of the automatic transmission before a torque converter assembly is attached thereto;

FIG. 3 is a plan view of the automatic transmission before the torque converter assembly is attached;

FIG. 4 is a bottom view of a bolt tightening device in accordance with the present invention;

FIG. 5 is a cross-sectional view of a bolt tightening mechanism in combination with a torque transmission mechanism in the bolt tightening device of the present invention;

FIG. 6 is a cross-sectional view taken along arrows A-A in FIG. 5;

FIG. 7 is a cross-sectional view of a torque input unit;

FIG. 8 is a cross-sectional view of a belt tension adjustment unit in an embodiment of the bolt tightening device of the present invention;

FIG. 9 is a cross-sectional view of the bolt tightening device when bolts are being held;

FIG. 10 is a cross-sectional view of the automatic transmission and the bolt tightening device of the present invention, prior to tightening of the bolts;

FIG. 11 is a cross-sectional view of the automatic transmission and the bolt tightening device after tightening of the bolts has been completed; and

FIG. 12 is a plan view of a dual bolt tightening device.

### DETAILED DESCRIPTION OF THE PREFERRED EMBODIMENTS

A preferred embodiment of the fastener tightening device of the present invention, used for attaching an oil pump assembly to an automatic transmission by simultaneously tightening seven bolts, will now be described with reference to the accompanying drawings.

(1) Overall Structure of the Automatic Transmission

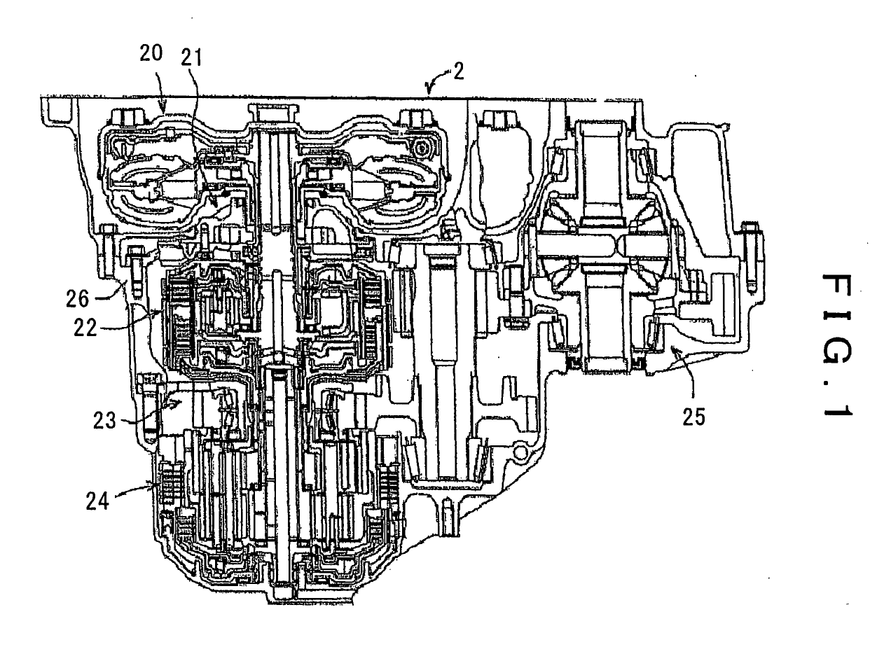

The overall structure of an automatic transmission on which the described preferred embodiment of the present invention is used is illustrated in FIGS. 1 to 3, and may be, for example, a front engine-front wheel drive (FF) vehicle or a rear engine-rear wheel drive (RR) vehicle. For example, the automatic transmission may be that disclosed in Japanese Patent Application Publication (“Kokai”) No. JP-A-2002-220704. Accordingly, although a general outline of the structure will be given here, a detailed explanation will be omitted.

FIG. 1 shows automatic transmission 2 as including a torque converter assembly 20, an oil pump assembly 21, a front sub-assembly 22, a counter gear assembly 23, a rear sub-assembly 24, and a differential assembly 25. These structural elements are housed in a housing 26. The oil pump assembly 21 supplies lubricant and hydraulic pressure for operation of the automatic transmission 2.

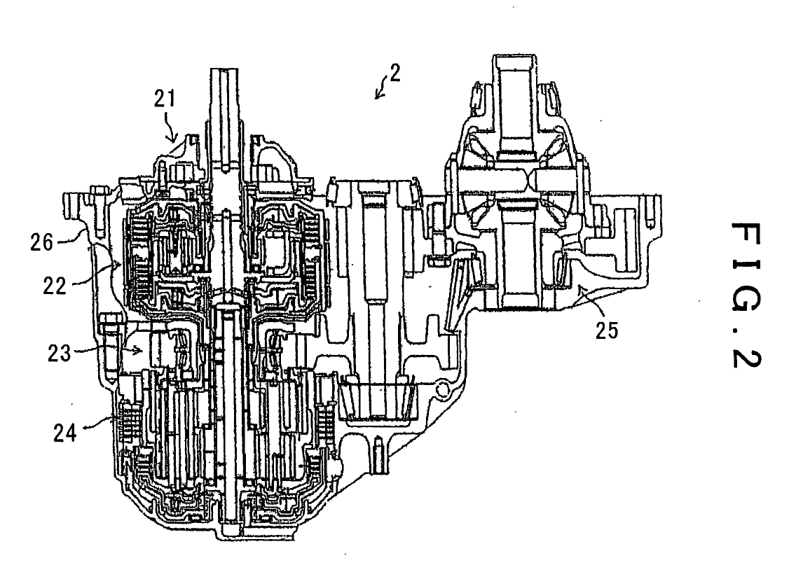

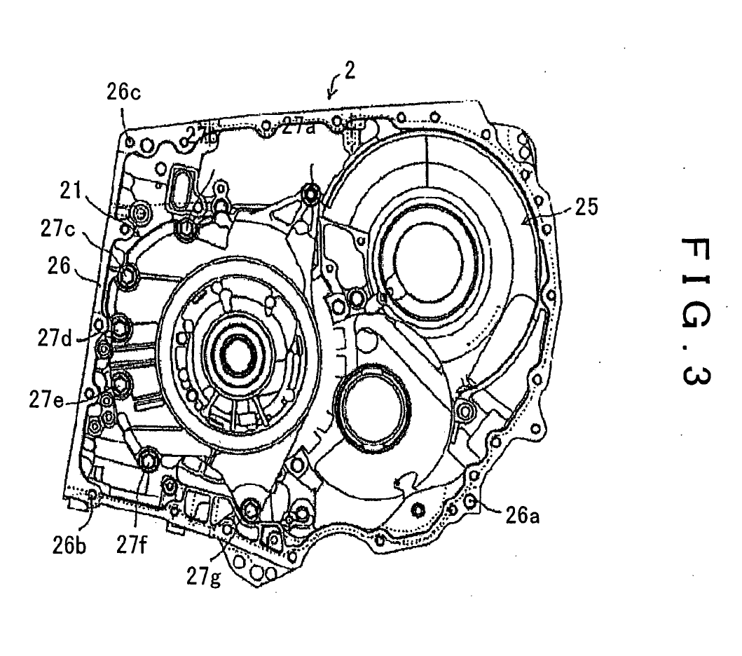

Referring to FIG. 2, the rear sub-assembly 24, the counter gear assembly 23, the differential assembly 25 and the front sub-assembly 22 are mounted in that order in the housing 26. Following this, the oil pump assembly 21 is attached to the top side of the front sub-assembly 22. More specifically, as shown in FIG. 3, the oil pump assembly 21 is fixed to the housing 26 by seven bolts 27a to 27g. Pins 26a to 26c are provided on the end surface of the housing 26 and used to position various structural elements when they are attached.

(2) The bolt Tightening Device of the Present Invention

(2.1) Structure of the Bolt Tightening Device

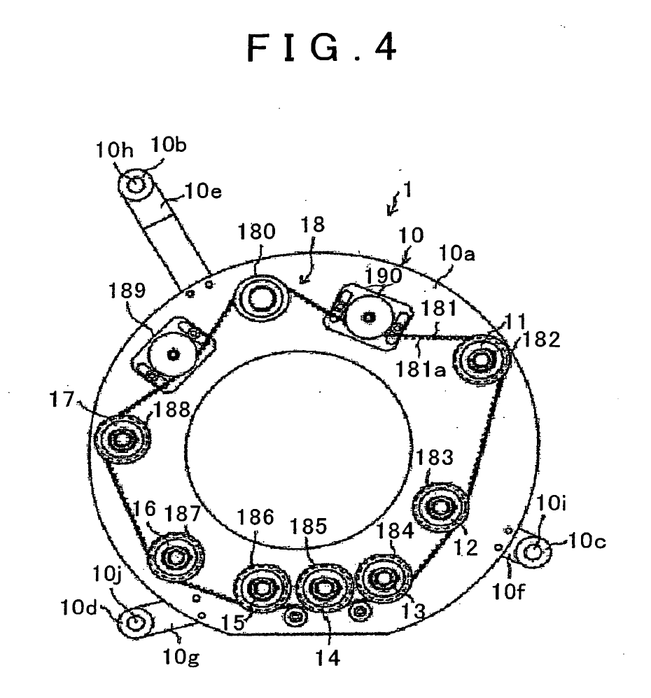

The structure of an embodiment of the bolt tightening device according to the present invention will now be explained with reference to FIGS. 4 to 8.

Referring to FIG. 4, a bolt tightening device 1 includes a main body (positioning unit) 10, bolt tightening mechanisms (rotary shafts) 11 to 17, and torque transmission mechanism 18.

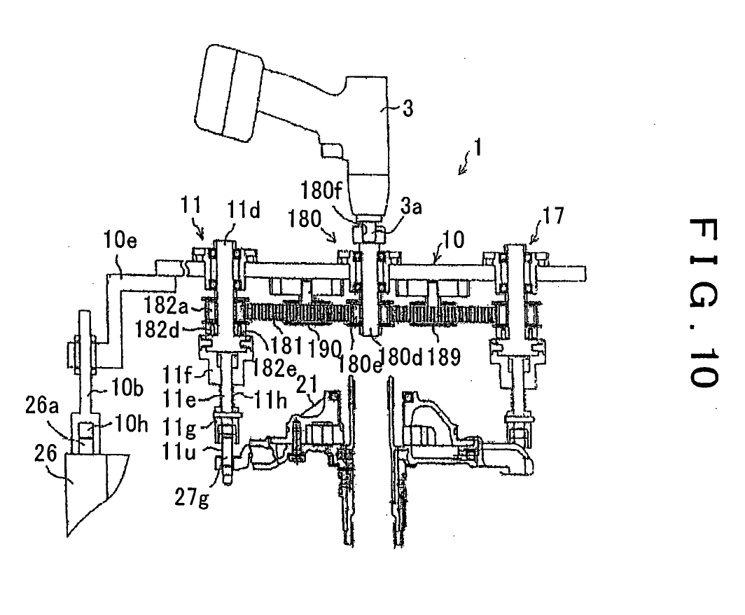

The main body 10 supports the bolt tightening mechanisms 11 to 17 and the torque transmission mechanism 18, and optimally positions the bolt tightening mechanisms 11 to 17 with respect to the bolt holes (described later with reference to FIG. 10) of the oil pump assembly 21. The main body 10 includes a support plate 10a, work holders 10b to 10d, and connectors 10e to 10g.

The support plate 10a has a generally circular shape and supports the bolt tightening mechanisms 11 to 17 and the torque transmission mechanism 18. A central opening is formed in the center of the support plate 10a to reduce its weight. Further, through holes are also formed in the support plate 10a at positions that correspond to the bolts that are to be tightened and receive the bolt tightening mechanisms 11 to 17 fitted thereinin.

The work holders 10b to 10d have a generally round cylindrical shape and mate with the pins 26a to 26c provided in the end surface of the housing 26 of the automatic transmission 2. Work engagement holes 10h to 10j are provided in the shaft ends of the work holders 10b to 10d to receive the pins 26a to 26c of the housing 26 (refer to FIG. 10). The connectors 10e to 10g are tabular (elongated plates) and connect the work holders 10b to 10d to the support plate 10a. The work holders 10b to 10d are fixed to the digital ends of the connectors 10e to 10g, and the base ends of the connectors 10e to 10g are fixed to the edge surface at the outer periphery of the support plate 10a. The work holders 10b to 10d in combination with the connectors 10e to 10g serve as one embodiment (example) of a “positioning means.”

When the work holders 10b to 10d are engaged with the pins 26c, 26b, 26d of the housing 26, the length and attachment angle of the connectors 10e to 10g are adjusted so that the bolt tightening mechanisms 11 to 17 are located at positions that correspond to the positions of the bolts that are to be tightened. Moreover, the axial lengths of the work holders 10e to 10g are selected so that the bolt tightening mechanisms 11 to 17 are positioned at heights suitable for firmly engaging the corresponding bolts that are to be tightened.

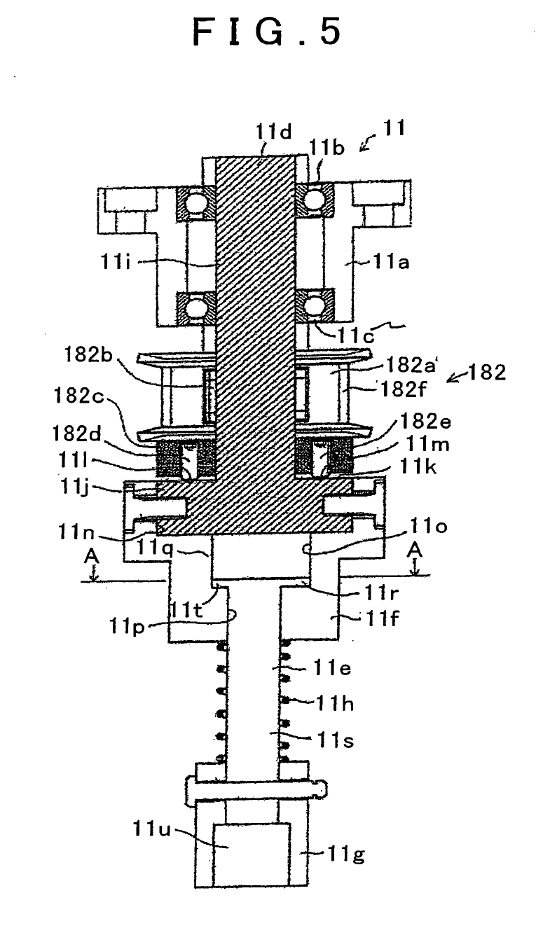

Since the bolt tightening mechanisms 11 to 17 have the same structure, only a single bolt tightening mechanism 11 will be described here with reference to FIG. 5. FIG. 5 shows the bolt tightening mechanism 11 as including a support member 11a, bearings 11b, 11c, rotary members 11d, 11e, a connecting member 11f, a bolt holder 11g, and a spring 11h.

The support member 11a is generally cylindrical and supports the rotary member 11d via the bearings 11b, 11c. The bearings 11b and 11c are inserted and fitted within a through hole provided in the support member 11a.

The rotary member 11d has a generally circular cylindrical shape and is rotated by torque transmitted via the torque transmission mechanism 18. The rotary member 11d has a small diameter portion 11i and a large diameter portion 11j. The small diameter portion 11i of the rotating member 11d is rotatably supported by the support member 11a via the bearings 11b, 11c. A step (shoulder) 11k extends between the small diameter portion 11i and the large diameter portion 11j of the rotating member 11d and is provided with engagement grooves 11l and 11m that receive therein ball plungers 182d, 182e, described later.

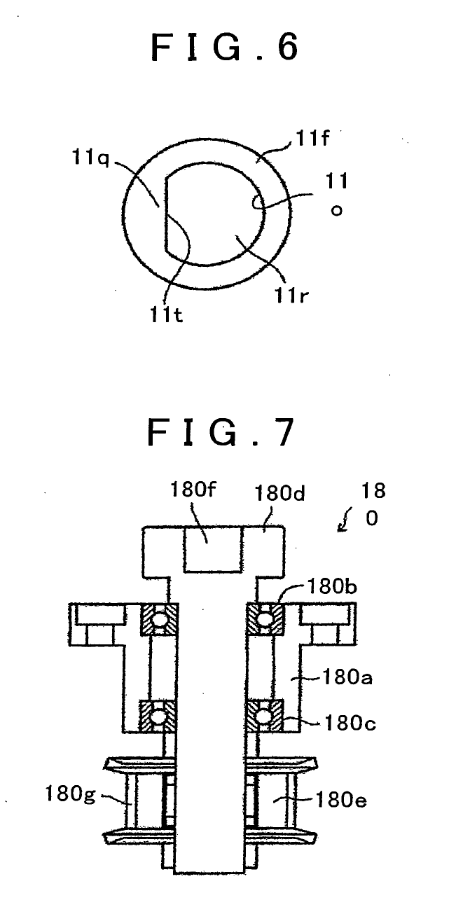

The connecting member 11f is generally tubular and (i) connects the rotary members 11d, 11e, and (ii) supports the rotary member 11e for sliding axial movement relative to rotary member 11e. A through hole, formed with a large inner diameter section 11n, a medium inner diameter section 11o and a small inner diameter section 11p, is provided in the connecting member 11f. The large inner diameter portion 11j of the rotary member 11d is seated within the large diameter section 11n of the through hole, and is fixed therein by screws extending inward from the outer periphery. Further, as can be seen in FIG. 6, a protruding section 11q protrudes within the medium diameter section 11o and reduces the diameter of the through hole therein.

Referring to FIG. 5, the rotating member 11e has a generally circular cylindrical shape, (i) is rotated by torque transmitted via the connecting member 11f, and (ii) slides axially. The rotatary member 11e is provided with a large diameter section 11r and a small diameter section 11s. As can be seen in FIG. 6, a protruding tab 11t is provided in the large diameter section 11r of the rotary member 11e. This protrusion (tab) 11t is engaged with the protruding section 11q of the medium diameter section 11o of the connecting member 11f. As is apparent from FIG. 5, the tab 11t of the rotary member 11e mates with the axially extending flat (planar) surface of section 11q of the medium diameter section 11o of the connecting member 11f such that the flat edge of tab 11t slides axially along the flat inner surface of section 11q. Thus, the rotary member 11e is locked against rotation relative to the connecting member 11f, so that the rotary member 11e and connecting member 11f rotate together (in unison), yet can slide in the axial direction relative to the connecting member 11f.

The bolt holder 11g has a circular cylindrical shape and a socket 11u which holds the bolt that is to be tightened. In addition, an axial hole extends axially within the bolt holder 11g, in which the rotary member 11e is seated. A magnet is provided in the socket 11u to hold the head of a bolt that is being tightened. More specifically, a small diameter section 11s of the rotary member 11e is seated within the axial hole, and is fixed therein by a pin inserted through the diameter thereof.

The spring 11h urges the bolt holder 11g toward the bolt which is to be tightened. The spring 11h is, for example, a coil spring, and is fitted around the rotary member 11e, between the connecting member 11f and the bolt holder 11g.

Returning to FIG. 4, the torque transmitting mechanism 18 transmits torque of an electric driver 3 (See FIG. 10) to the bolt tightening mechanisms 11 to 17 as is apparent from FIG. 4. The torque transmission mechanism 18 is disposed between the support plate 10a of the main body 10 and the bolt tightening mechanisms 11 to 17. The torque transmission mechanism 18 includes a torque input unit 180, a toothed belt 181, torque transmission units (torque limiting units) 182 to 188, and belt tension adjustment units (tension adjustment units) 189, 190.

The torque input unit 180 uses the torque from the electric driver 3 to drive the toothed belt 181, and is mounted within one of the through holes provided in the support plate 10a of the main body 10. As can be seen in FIG. 7, the torque input unit 180 has a support member 180a, bearings 180b, 180c, a rotary member 180d, and a toothed pulley 180e.

The support member 180a has a generally hollow cylindrical shape and supports the rotary member 180d via the bearings 180b and 180c. The bearings 180b, 180c, in turn, are fitted within the aforementioned through hole provided in the support member 180a.

The rotary member 180d has a generally circular cylindrical shape and is rotably driven by the torque of the electric driver 3. An engagement socket 180f, provided at one end of the rotary member 180d, receives and mates with the drive member 3a at the tip end of the electric driver 3. The rotary member 180d is rotatably supported by the support member 180a via the bearings 180b, 180c.

The toothed pulley 180e has teeth 180g around its outer surface which mesh with the toothed belt 181, thereby transmitting torque of the rotary member 180d, to which it is fixed, to the toothed belt 181.

As is apparent from FIG. 4, the toothed belt 181 transmits torque from the torque input unit 180 to the torque transmission (torque limiting) units 182 to 188. Teeth 181a are formed on the inner surface of the toothed belt 181 and mesh with toothed pulley 180e and the toothed pulleys of the torque transmission (torque limiting) units 182 to 188, described later. The toothed belt 181 simultaneously and continuously engages all of the toothed pulleys and thus connects them.

The torque transmission units 182 to 188 transmit torque from the toothed belt 181 to the bolt tightening mechanisms 11 to 17. All torque transmission units 182 to 188 have the same structure as shown in FIG. 5. Referring to FIG. 5, the torque transmission unit 182, for example, includes a toothed pulley 182a, a bearing 182b, a fixed member 182c, and the ball plungers 182d, 182e.

The toothed pulley 182a transmits torque received from the toothed belt 181 to the member 182c fixed thereto. Teeth 182f formed in the outer surface of the toothed pulley 182a mesh with the toothed belt 181. The toothed pulley 182a is rotatably supported by the rotary member 11d between the support member 11a and the connecting member 11f via the bearing 182b.

The fixed member 182c has the shape of a circular plate and serves to fix the ball plungers 182d, 182e to the toothed pulley 182a. A through hole is formed in the center of the fixed member 182c through which the rotary shaft 11d passes. In addition, holes into which the ball plungers 182d, 182e are fitted are formed in the fixed member 182c. The fixed member 182c is fixed to the end surface of the toothed pulley 182a on the side of the connecting member 11f.

The ball plungers 182d, 182e have a generally circular cylindrical shape. When a predetermined amount of external force is applied to the ball plungers 182d, 182e, the tiny balls provided at the tips of the ball plungers 182d, 182e are axially displaced inward of the fixed member 182c. In transmitting torque, the tips of the ball plungers 182d, 182e are engaged within the engagement grooves 11l, 11m provided in the annular surface 11k of the large diameter portion of rotary member 11d.

Torque received by the toothed pulley 182a is transmitted to the rotary member 11d via the fixed member 182c and the ball plungers 182d, 182e. When the torque of the toothed pulley 182a becomes equal to or more than a predetermined torque, the external force, applied to the tips of the ball plungers 182d, 182e via the engagement grooves 11l, 11k of the rotating member 11d, displaces the tiny balls in the tips axially inward of the fixed member 182c. When the balls in the tips of the ball plungers 182d, 182e are thus displaced, the tips separate from the engagement grooves 11l, 11m of the rotary member 11d and thus transmission of torque to the rotary member 11d is stopped. Accordingly, the bolts are tightened to the predetermined torque.

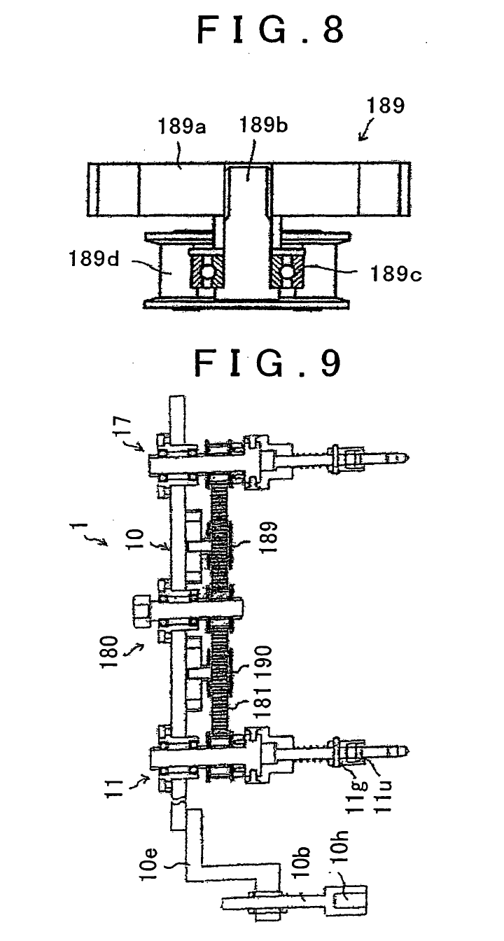

The belt tension adjustment units 189, 190 are fixed to the support plate 10a of the main body 10, and allow adjustment of the tension of the toothed belt 181. The belt tension adjustment units 189, 190 all have the same structure, and the following explanation will treat only belt tension adjustment unit 189 by way of example. Referring to FIG. 8, the belt tension adjustment unit 189 includes a support member 189a, a fixed member 189b, a bearing 189c, and a pulley 189d.

The support member 189a is a rectangular plate which supports the fixed member 189b and has elongated holes for adjusting the position of the support member 189a. The fixed shaft 189b has a generally circular cylinder shape and rotatably supports the pulley 189d via the bearing 189c at a position where the pulley 189d is pushed against the outer surface of the toothed belt 181.

(2.2) The Operation of the Bolt Tightening Device

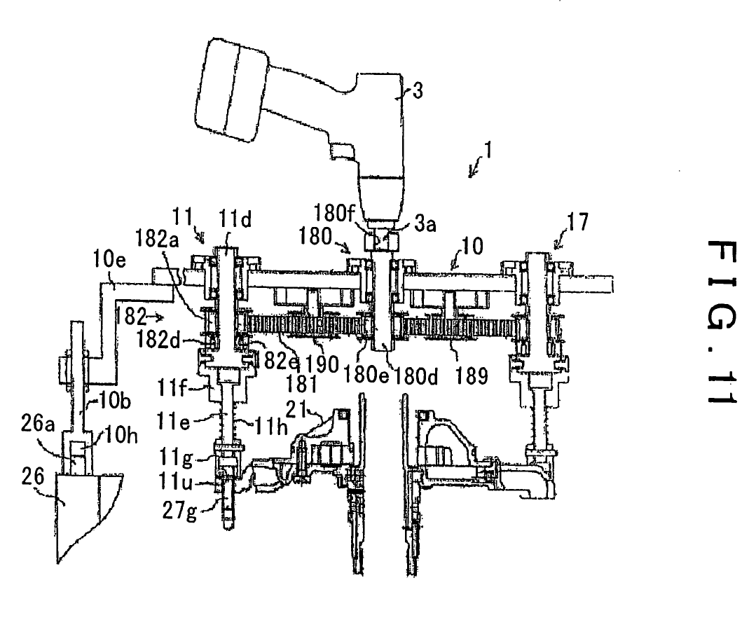

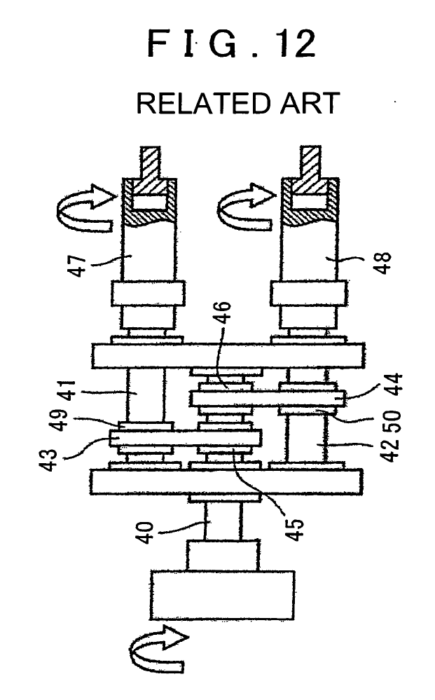

The operation of the bolt tightening device 1 will now be explained with reference to FIG. 4, and FIGS. 9 to 11. Note that, the cross-sectional views of FIGS. 9 to 11 do not show the bolt tightening mechanisms 13 to 17, the work holders 10c, 10d, or the connectors 10f, 10g. Further, FIGS. 10 and 11 show only the portion of the automatic transmission 2 that includes the oil pump assembly 21 and a section of the housing 26. Other portions of the automatic transmission 2 are omitted.

Referring to FIG. 9, an operator places the head of a bolt 27g in the socket 11u of the bolt holder 11g of the bolt tightening mechanism 11. The magnet provided in the socket 11u of the bolt holder 11g holds the head of the bolt 27g within the socket 11u. Bolts are held by the bolt tightening mechanisms 12 to 17 in a similar manner.

Next, referring to FIG. 10, the operator brings the work engagement hole 10h of the main body 10 into engagement with the pin 26a provided on the end surface of the housing 26 of the automatic transmission 2. The work engagement holes 10i, 10j receive the other pins 26b, 26c provided at different positions on the end surface of the housing 26. As a result, the bolt tightening device 1 is fixed to the housing 26 with the tip ends of the bolts inserted in the bolt holes of the oil pump assembly 21. At this time, the rotary member 11e is pushed against the bolt 27g and slides inward within the connecting member 11f side while urged toward the oil pump assembly 21 by the force of spring 11h acting on the bolt holder 11g. The operation of the bolt tightening mechanisms 12 to 17 is the same as that described above.

In the above state the drive end 3a of the electric driver 3 is engaged within the socket 180f of the torque input unit 180. As a result of operation of the electric driver 3, the toothed pulley 180e fixed to the rotary member 180d is rotated. As will be apparent from FIG. 4, the torque received by the toothed pulley 180e is transmitted to the torque transmission units 182 to 188 through the toothed belt 181. The torque received by the torque transmission unit 182, for example, is then transmitted to the rotary member 11d through the toothed pulley 182a, and the ball plungers 182d, 182e. When the rotary member 11d is rotated, the bolt holder 11g and the rotary member 11e connected via the connector 11f rotate, whereby the bolt 27g is tightened. The torque transmission units 183 to 188 and the bolt tightening mechanisms 12 to 17 operate in a similar manner.

The bolt 27g is tightened until the inner surface of the head comes into contact with the face of the oil pump assembly 21, as shown in FIG. 11. Then, when the torque becomes equal to or greater than the predetermined amount, the tiny balls of the tips of the ball plungers 182d, 182e are displaced inward in the axial direction, away from the engagement grooves 11l, 11m of the rotating member 11d, and torque is no longer transmitted. As a result, the bolt 27g is tightened to the predetermined torque. The torque transmission units 183 to 188 and the bolt tightening mechanisms 12 to 17 operate in the same manner as described above.

(2.3) Advantages of the Bolt Tightening Device

The advantages of the bolt tightening device 1 will now be described. The bolt tightening device 1 simultaneously tightens the seven bolts 27a to 27g by transmitting torque to the bolt tightening mechanisms 11 to 17 through the single toothed belt 181, a configuration which has a reduced number of components and cost, as compared to the previously described prior art in which a toothed belt is provided for each rotating shaft. In addition, with the configuration of the bolt tightening device 1, the torque input unit 180 need have only a single toothed pulley 180a for meshing with the toothed belt 181. As a result, as compared to the previously described prior art in which the toothed pulleys are arranged in a serial alignment on the drive shaft, the axial dimension of the bolt tightening device 1 can be reduced. Accordingly, the bolt tightening device 1 can be made smaller, more lightweight and easier to use.

In addition, in the bolt tightening device 1, the torque transmission units 182 to 188 discontinue transmission of torque when the torque transmitted by the bolt tightening mechanisms 11 to 17 becomes equal to or greater than the predetermined torque. Accordingly, the bolts 27a to 27g can be tightened to the predetermined torque.

Furthermore, in the bolt tightening device 1, the belt tension adjustment units 189, 190 are utilized to adjust the tension of the toothed belt 181. As a result, the teeth of the toothed belt 181 are reliably meshed with the teeth of the toothed pulleys of the torque transmission units 182 to 188 to reliably transmit the torque.

In addition, because the bolt tightening device 1 engages the work holders 10b, 10c, and 10d of the main body 10 with the pins 26c, 26a, 26b of the housing 26, the bolt tightening mechanisms 11 to 17 are properly positioned in alignment with the bolt holes of the oil pump assembly 21. Thus, there is no need to further adjust the position of the bolt tightening device 1, which makes the bolt tightening device 1 easier to use.

(3) Other Embodiments

The above embodiment represents but one example of the fastener tightening device according to the present invention, i.e. adapted for tightening the bolts of the oil pump assembly 21 of the automatic transmission 2. However, the present invention is not so limited. The fastener tightening device according to the present invention may be used for any application which requires a plurality of bolts, screws, etc to be tightened.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A fastener tightening device comprising:
a plurality of rotary shafts having respective fastener holders for holding fasteners to be tightened by turning; and
a torque transmission unit including a single belt for simultaneously transmitting torque input from an external source to all of the plurality of rotary shafts to rotatably drive the fastener holders.

2. The fastener tightening device according to claim 1, further comprising:
a torque limiting unit for limiting the torque of at least one of the plurality of rotary shafts to a predetermined torque.

3. The fastener tightening device according to claim 1, further comprising:
a pulley disposed on each of the rotary shafts and engaging the belt for transmission of torque from the belt to the rotary shafts; and
a torque limiting unit associated with each of the pulleys for limiting the torque transmitted to the rotary shafts to a predetermined torque.

4. The fastener tightening device according to claim 3, further comprising:
at least one tension adjustment unit for adjusting the tension of the belt.

5. The fastener tightening device according to claim 4, further comprising:
positioning means for positioning the plurality of rotary shafts in alignment with positions on a work where the fasteners are to be tightened.

6. The fastener tightening device according to claim 3, further comprising:
positioning means for positioning the plurality of rotary shafts in alignment with positions on a work where the fasteners are to be tightened.

7. The fastener tightening device according to claim 2, further comprising:
at least one tension adjustment unit for adjusting the tension of the belt.

8. The fastener tightening device according to claim 7, further comprising:
positioning means for positioning the plurality of rotary shafts in alignment with positions on a work where the fasteners are to be tightened.

9. The fastener tightening device according to claim 2, further comprising:
positioning means for positioning the plurality of rotary shafts in alignment with positions on a work where the fasteners are to be tightened.

10. The fastener tightening device according to claim 1, further comprising:
at least one tension adjustment unit for adjusting the tension of the belt.

11. The fastener tightening device according to claim 10, further comprising:
positioning means for positioning the plurality of rotary shafts in alignment with positions on a work where the fasteners are to be tightened.

12. The fastener tightening device according to claim 1, further comprising:
positioning means for positioning the plurality of rotary shafts in alignment with positions on a work where the fasteners are to be tightened.
